(19) United States
(12) Patent Application Publication
(10) Pub. No.: US 2026/0273418 A1
(43) Pub. Date: Sep. 17, 2026

(54) AI-DRIVEN QUERYABLE PLATFORM FOR VIDEO GAME DATA

(71) Applicant: SONY INTERACTIVE ENTERTAINMENT INC., Tokyo (JP)

(72) Inventors: Bob Jordan, Alameda, CA (US); Dustin Clingman, San Francisco, CA (US); Christopher Fife, San Francisco, CA (US)

(21) Appl. No.: 19/081,933

(22) Filed: Mar. 17, 2025

(51) Int. Cl. A63F 13/67; A63F 13/86

(52) U.S. Cl. CPC A63F 13/67; A63F 13/86

(57) ABSTRACT

Techniques to facilitate querying of video game-specific features are provided. In an example, a computing system is provided that may receive, from a device associated with a first user, a query for a video associated with a video game. The query may indicate a first operational context for an event in the video game. In response to receiving the query, the computing system may identify a video of the event by determining that metadata associated with the video matches the first operational context indicated in the query. The video of the event may correspond to a game play of the video game by a second user. The metadata may be generated by an AI-model and may indicate a second operational context associated with the game play. The computing system may then transmit a query result indicative of the video to the device.

### BACKGROUND

Video games are available on different computing devices. For example, a video game developer may develop the same game for users of a first video game platform, a second video game platform, or both. In addition, video games are available from different sources. For example, a video game console associated with the first video game platform is operable to play multiple video games from two or more different video game developers.

Given the increasing number of video games from different developers, the user experience typically changes from one video game to the next. For example, the way game play help may be sought can vary significantly between video games. In addition, the way a particular part of a video game is surfaced on a computing device as being available for playing can be unique to the particular video game.

Hence, the user experience may not be common between video games. Accordingly, there is a need for improving the user experience such that, regardless of the underlying video games, some commonality in video game functionalities becomes possible.

### BRIEF SUMMARY

Embodiments of the present disclosure relate to techniques for providing query results related to events in video games. In some embodiments, a method implemented by a computer system is provided. The method may include receiving, from a device associated with a first user, a query for at least one video associated with a video game, the query indicating a first operational context for an event in the video game; in response to receiving the query: identifying a video of the event by determining that metadata associated with the video matches the operational context indicated in the query, the video of the event corresponding to a game play of the video game by a second user, and the metadata being generated by an AI-model and indicating a second operational context associated with the game play; and transmitting a query result indicative of the video to the device.

In some embodiments, the query corresponds to a natural language input of the first user via the device.

The method may further include, prior to receiving the query, receiving a video game signal and video game data related to the game play of the video game by the second user, the video game data comprising the video of the event, the metadata data generated by the AI-model based on the video game signal.

In some embodiments, the video game signal comprises one or more of: a controller input, an audio input, a chat input, settings of the video game, and settings of a controller or a video game device used by the second user for the game play.

In some embodiments, the metadata is generated by inputting the video game data and the video game signal to the AI-model, the metadata comprising an indication of the event being shown in the video and the second operational context that describes the video game signal.

In some embodiments, the second operational context comprises one or more of: a controller input of the second user for the game play, an indication of speed for the controller input, an indication of completion time of the event shown in the video, settings of the video game, and settings of a controller or a video game device used by the second user for the game play.

In some embodiments, identifying the video of the event comprises: determining, based on an indication of the event from the metadata, that the video shows the event; and determining, based on the second operation context describing the video game signal, that the second operational context matches a description of a queried video game signal indicated by the first operational context.

In some embodiments, transmitting the query result comprises transmitting a copy of the video to the device or a network address of a storage location of the video to the device.

In some embodiments, the metadata is generated by inputting video game data and a video game signal corresponding to the game play to the AI-model.

In some embodiments, the AI-model is configured to generate a second embedding of the second operational context in a latent space of the AI-model, and the video is identified by at least generating a first embedding of the first operational context and matching the first embedding with the second embedding.

In some embodiments, the metadata further comprises at least one of: an identifier of the second user, a game session of the game play, or a time of when the game play occurred.

In some embodiments, a computer system is provided. The computer system may comprise one or more processors and one or more memories storing computer-readable instructions. Upon execution by the one or more processors, the computer-readable instructions may configure the computer system to perform operations comprising receiving, from a device associated with a first user, a query for at least one video associated with a video game, the query indicating a first operational context for an event in the video game; in response to receiving the query: identifying a video of the event by determining that metadata associated with the video matches the operational context indicated in the query, the video of the event corresponding to a game play of the video game by a second user, and the metadata being generated by an AI-model and indicating a second operational context associated with the game play; and transmitting a query result indicative of the video to the device.

In some embodiments, one or more non-transitory computer-readable media are provided. The computer-readable media may store computer-readable instructions that, upon execution on a computer system, cause the computer system to perform operations comprising receiving, from a device associated with a first user, a query for at least one video associated with a video game, the query indicating a first operational context for an event in the video game; in response to receiving the query: identifying a video of the event by determining that metadata associated with the video matches the operational context indicated in the query, the video of the event corresponding to a game play of the video game by a second user, and the metadata being generated by an AI-model and indicating a second operational context associated with the game play; and transmitting a query result indicative of the video to the device.

### BRIEF DESCRIPTION OF THE DRAWINGS

FIG. 1 illustrates an example of a computing environment for collecting and processing video game events and video game queries, according to embodiments of the present disclosure.

FIG. 2 illustrates an example of a system architecture for providing contextual information related to a video game, according to embodiments of the present disclosure.

FIG. 3 illustrates an example of a system for generating metadata describing video game content, according to embodiments of the present disclosure.

FIG. 4 illustrates an example of a system for providing a query result in response to a query associated with a video game, according to embodiments of the present disclosure.

FIG. 5 illustrates an example of a system architecture for generating metadata describing video game content, according to embodiments of the present disclosure.

FIG. 6 illustrates an example of a system architecture for providing a query result in response to a query associated with a video game, according to embodiments of the present disclosure.

FIG. 7 is a schematic example of a computing environment for providing a query result in response to a query associated with a video game, according to embodiments of the present disclosure.

FIG. 8 is a flowchart of an example of a method for providing a query result in response to a query associated with a video game, according to embodiments of the present disclosure.

FIG. 9 illustrates an example of a hardware system suitable for implementing a computer system, according to embodiments of the present disclosure.

### DETAILED DESCRIPTION

Generally, systems and methods for improving a user video game experience are described. In an example, the user video game experience is improved by providing a unified way for, among other things, videos of game play of video games to be queried regardless of the underlying video games. This unified way need not change how a video game is developed or necessitate a common approach to video game development. Instead, analysis of videos of video games and metadata generation for the videos is generated using artificial intelligence (AI) and relied upon, where a queryable platform (e.g., a server-based video game service) can collect and process such videos based on the execution of the video games. The queryable platform can further provide query results with one or more of the videos in response to queries from user devices to customize such query results at the client level.

For instance, the queryable platform may receive, from a device associated with a first user, a query for a video associated with a video game. The query may indicate a first operational context for an event in the video game. That is, the query may define an aspect of the event in the video game that is of interest to the user. Then, in response to receiving the query, the queryable platform can identify a video of the event. To do so, the queryable platform may determine that metadata associated with the video matches the first operational context indicated in the query. The queryable platform can then transmit a query result indicative of the video to the device.

To illustrate, consider an example of an event in a video game that includes capturing a flag of an adversary. A query may be received by queryable platform and from a user device that indicates the event (e.g., the capturing of the flag of the adversary) and an operational context of the event. The operational context may include a location of the flag and an obstacle in the location. Given the event indicated in the query, the queryable platform identifies a video of the video game in which the flag is captured. The video may include a game play of the video game in which a second user used a sledgehammer to break an entrance door and a rope to climb over the obstacle. The video may be associated with metadata that indicates the event, a player ID of the second user, and the obstacle. To identify the video, the queryable platform determines a match between the operational context indicated in the query and the metadata associated with the video. For example, the queryable platform may identify key words from the query related to the event and the obstacle. Then, the queryable platform may identify the key words or similar key words in the metadata to determine the match between the operational context and the metadata. As a result of identifying the video, the queryable platform transmits a query result indicative of the video to the user device. For example, the queryable platform may transmit a link to the video to the user device.

Embodiments of the present disclosure provide many technical advantages over existing video game platforms. In particular, a user interface (e.g., GUI) is improved relative to existing user interfaces because relevant video or other query results can be presented therein in a common manner across different applications and different computing devices. For instance, by analyzing a query that includes an event in a video game and an operational context for the event, a queryable platform of the present disclosure can accurately determine query results (e.g., videos) of interest to a user. Because an accurate determination can be performed, multiple video game functionalities become possible. In particular, a relevant video and corresponding description of the video can be presented on a user interface in a presentation manner common to different types of computing devices (e.g., the same information can be surfaced on a video game console and on a mobile device). Hence, different query results can be provided in a common manner across the video games and computing devices.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

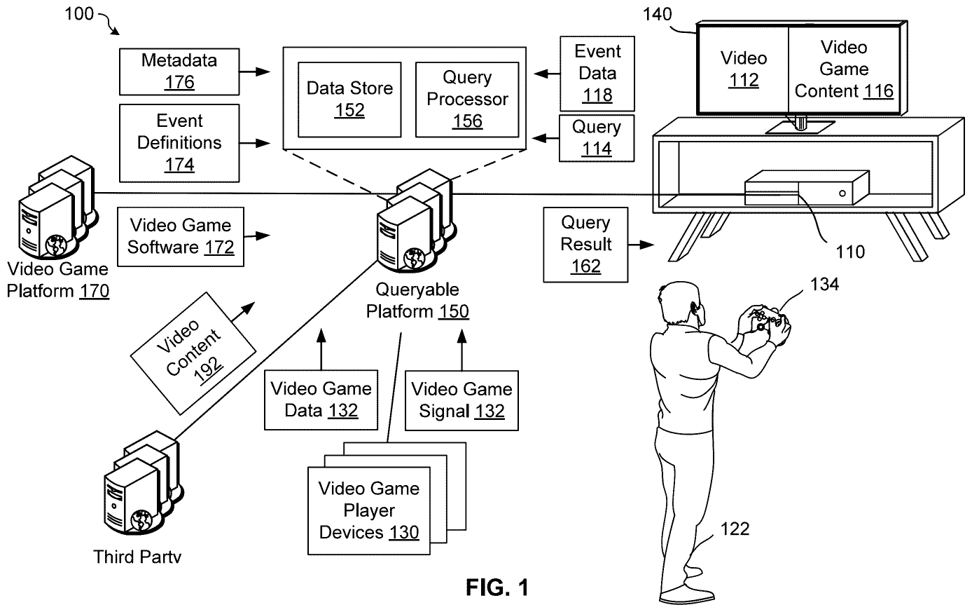

FIG. 1 illustrates an example of a computing environment 100 for collecting and processing video game events and video game queries, according to embodiments of the present disclosure. As illustrated, the computing environment includes a video game console 110, video game player devices 130, a queryable platform 150, a video game platform 170, and a third-party system 190. Video games may be available to the video game console 110 from the video game platform 170. The queryable platform 150 may collect, store, and process events from the video game player devices 130, the video game platform 170, and the third-party system 190 to provide video game-related data in a unified and queryable way for each video game.

In an example, the video game console 110 represents a computing device available to a user 122 and operable to interact with one or more applications including video games. A display 140 communicatively coupled or integrated with the video game console 110 can present video game-related data, including video game content 116 and video 112, to the user 122. Other types of computing devices can be available to the user 122 including for instance, a smartphone, a tablet, a laptop, a desktop computer, or other devices with suitable memories and processors.

The video game console 110 can execute a video game locally to present the video game content 116 on the display 140. Additionally, or alternatively, the video game consoles 110 can receive the video game content 116 based on an execution of an instance of the video game application on the video game platform 170 or another remote computer system. The video game can also be downloadable to the video game console 110 from such systems.

Further, the video game console 110 can, directly or through the video game platform 170, download or stream video content (e.g., video 112) from the queryable platform 150 for presentation on the display 140. An example of video content includes a video file uploaded to the queryable platform 150 from the third-party system 190, where this video file demonstrates how a video game can be played, how a set of activities in the video game can be played, or how a set of mechanics in an activity can be used to play the activity. Another example of video content includes a video file of an event in a video game that is labeled with metadata and uploaded to the queryable platform 150. Moreover, another example of video content includes a video file generated by one of the video game player devices and uploaded to the queryable platform 150 directly or through the third-party system 190 or the video game platform 170, where the video file records game play of a video game player operating the video game player device. Likewise, a similar video file can be uploaded to the queryable platform 150 from the video game console 110.

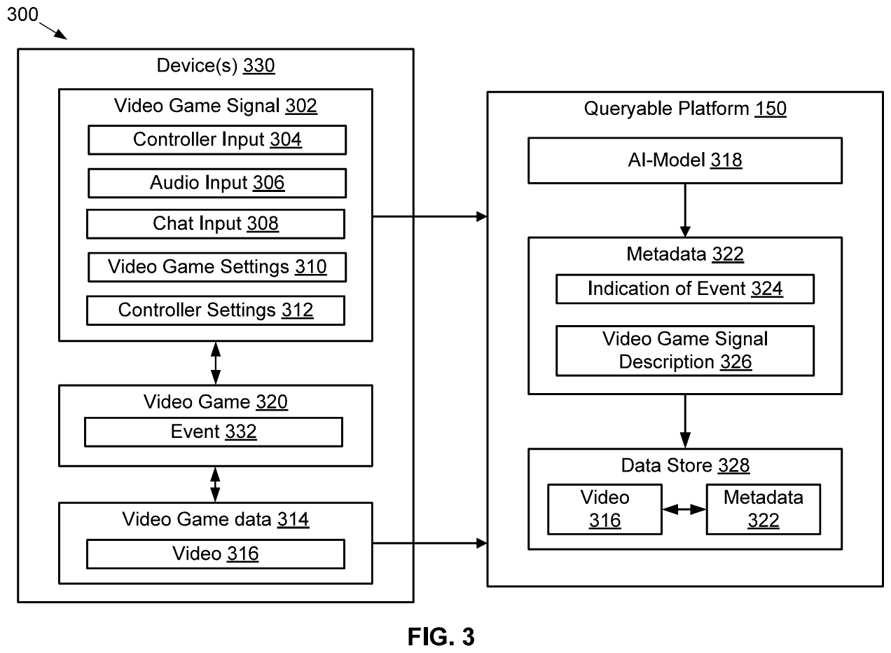

The video game console 110 may download or stream video content (e.g., video 112) from queryable platform 150 for presentation on the display 140 in response to a query 114 submitted by the user 122. The query 114 may be received as a natural language input from one of the video game player devices 130 or the video game console 110. For example, the query 114 may be an audio input (e.g., speech) received by a microphone of a video game player device 130 or the video game console 110. In another example, the query 114 may be a textual input that is input by the user using a controller or other video game player device 130. The query 114 may then be transmitted from the video game player device 130 or the video game console 110 to the queryable platform 150. In response, the queryable platform 150 can process the query 114 (e.g., via a query processor 156) and return a query result 162 to the video game console 110 or the video game player device 130. The query result 162 may include the video content (e.g., video 112) that can be downloaded or streamed by the video game console 110 for presentation on the display 140. The processing of queries and providing of query results is described in further detail below with respect to FIGS. 3-9.

In an example, the video game player devices 130 represent computing devices of video game players that may, but need not, include the user 122. A controller 13 is one example of a video game player device. Similar functionalities can be provided on each one of the video game player devices and the video game console 110.

In an example, the video game platform 170 represents a computer system that includes a set of computing resources for developing, deploying, or a combination thereof video games. In particular, the video game platform 170 can store video game software 172, upload such software 172 to the queryable platform 150, and/or download such software 172 to the video game console 110.

The video game software 172 of a video game is program code executable to present and interact with video game content of the video game. The program code can include predefined instrumentations to generate events upon the execution of the program code. In particular, the program code includes a set of event definitions 174, where an event definition represents code defining an identifier of an event and data to be reported for the event. Examples of such event definitions 174 are further described herein below and are predefined in the program code of the video game according to event templates available from the video game platform 170. Such event templates can be defined by a service provider of the video game platform 170.

In an example, the third-party system 190 represents a computer system, such as one or more content servers, for providing video content 192 to the video game console 110 directly or indirectly through the queryable platform 150 or the video game platform 170. As explained herein above, the video content 192 can include video files demonstrating how a video game can be played, how a set of activities in the video game can be played, how an event in a video game has been played by another player, or the like. The video content 192 can be uploaded to the third-party system 190 from the video game platform 170, the video game console 110, and/or one or more of the video game player devices 130 directly or indirectly. The video content 192 can further be stored by the queryable platform 150 (e.g., in data store 152) and/or used by the queryable platform 150 in a query result 162.

Additionally, in an example, the video game platform 170 represents a computer system that provides various video-game related functionalities to the video game console 110. For instance, the video game platform 170 may be communicatively coupled with the video game console 110, the video game player devices 130, the queryable platform 150, and third-party system 190. In particular, the video game software 172 and the video content 192 can be downloaded to the video game consoler 110 through the video game platform 170. An instance of a video game based on video game software stored on the video game platform 170 can be instantiated for the video game console 110. A video file can be streamed through the video game platform 170 to the video game console 110. And communications data (e.g., messages, commands, etc.) can be exchanged between the video game console 110 and the video game player devices 130 through the video game platform 170.

In an example, the queryable platform 150 receives content metadata 176 for video games from the video game platform 170. Content metadata 176 may include definitions for individual and/or discrete instance of game content available within a video game. There may be one or more types of content metadata 176. The types of content metadata may correspond to the common types of content within video games, such as activities, actors, mechanics, zones, or the like, as further described above. Each type of content metadata may include one or more fields and/or attributes that are common to that particular type of content, as described further herein.

In an example, the queryable platform 150 receives content event definitions 174 for the content in video games from the video game platform 170. Content event definitions 174 may include definitions for individual instances of events and/or actions that can occur in relation to a corresponding instance of game content during execution of a video game. Content event definitions 174 may include one or more types of event definitions. The types of content event definitions may correspond to the common types of events and/or actions that occur within video games in relation to corresponding types of game content. Each type of content event definition may include one or more fields and/or attributes that are common to that particular type of event, as described further herein. In some embodiments, content event definitions include one or more fields and/or attributes for derived data, such as network configurations.

Generally, an activity is a unit of game play inherent to the structure of a video game. Different categories of activities exist including progress activities, competitive activities, challenge activities, and open-ended activities. While described as activities, other methods of defining units of gameplay that are discrete and distinguishable within the structure of a video game are possible. The one or more fields and/or attributes in the content metadata for an activity may include an activity identifier, a name, and a category. The activity identifier is a unique identifier of the activity. Corresponding event definitions may refer to the activity identifier. The name can be a short, localized name of the activity. Other properties are possible including, for instance, a description (e.g., a longer description of the activity), an image of the activity, a default availability (e.g., whether the activity is available to all video game players before launching the video game), whether completion of the activity is required to complete the video game, whether the activity can be played repeatedly in the video game, and nested Tasks (child activities, also referred to herein as sub-activities). Multiple types of event definitions for activities are possible.

An example of an event about an activity can indicate changes in activity availability for a video game player (e.g., the user 122). This is primarily used to decide what activities to display and to remove spoiler block for those activities (where an activity having a spoiler may not be surfaced to the video game player). A property of this event may include, for instance a list (e.g., array) of activities that are currently available.

An example of an event about an activity can indicate that a video player is currently participating in the activity or task (e.g., a child activity). A property of this event may include, for instance the activity identifier of the activity. Another property can optionally be a time corresponding to the start of the participation in the activity.

An example of an event about an activity can indicate the end of the activity or task (e.g., a child activity). A property of this event may include, for instance the activity identifier of the activity. Another property can optionally be a time corresponding to the end of the participation in the activity. Yet another property can optionally be an outcome of the activity, such as completed, failed, or abandoned.

The video game platform 170, the queryable platform 150, or a combination thereof can also collect data about a zone in a video game. The zone may represent an area of a game world of the video game (e.g., a virtual world) with a single coordinate system. A zone may have a two-dimensional (2-D) map image associated with it, used to display locations on the zone. The one or more fields and/or attributes in the content metadata for zones may include a zone identifier and a name. The zone identifier is a unique identifier of the zone. The name can be a short localizable name of the zone. Other properties are possible including, for instance, an indication of whether the object should be treated as hidden for spoiler block uses cases (the default may be set to false), a map (e.g., a high resolution image for the zone 2-D map), a view projection (e.g., a matrix (4×4) to convert from three-dimensional (3-D) work coordinates to 2-D map position), and an image (e.g., a display image for the zone if different from the map). Multiple types of events about zones are possible.

An example of an event about a zone can indicate an update to the current in-game location of the video game player. This event can be reported regularly, or whenever the player's in-game location changes significantly. A property of this event includes the zone identifier. Other properties are possible, such as optionally position (e.g., x, y, z position of the video game player character (the virtual player of the video game player) in the zone) and orientation (e.g., x, y, z vector indicating the video game player character's direction).

Another example of an event about a zone can indicate the video game player's zone, location, and orientation, at the time of starting an activity. This event can enable location-based help. A property of this event includes the activity identifier. Other properties are possible, such as optionally the zone identifier and the position and orientation of video game player's character in the video game.

Yet another example of an event about a zone can indicate the video game player's zone, location, and orientation, at the time of ending an activity. This event can also enable location-based help. A property of this event includes the activity identifier. Other properties are possible, such as optionally the outcome of the activity, the zone identifier, and the position and orientation of video game player's character in the video game.

The video game platform 170, the queryable platform 150, or a combination thereof can also collect data about an actor in a video game. The actor can represent an entity with behaviors in the video game. The actor can be player-controlled or game-controlled, and this can change dynamically during game play. The one or more fields and/or attributes in the content metadata for an actor can include an actor identifier and a name. The actor identifier is a unique identifier of the actor. The name can be a localizable name of the actor. Other properties are possible including, for instance, an indication of whether the object should be treated as hidden for spoiler block uses cases (the default may be set to false), an image of the actor, and a short description of the actor. Multiple events about actors are possible.

An example of an event about actor(s) can indicate that a change to the video game player's selection of actor(s). Selected actors represent the actors the video game player is controlling in the video game, and can be displayed on the video game player's profile and other presentation spaces. There can be more than one actor selected at a time. The video game should replace the list of actors upon loading save data. A property of this event includes a list (e.g., array) of actors which are currently selected by the video game player.

The video game platform 170, the queryable platform 150, or a combination thereof can also collect data about a mechanic in a video game. A mechanic may represent an item (e.g., tool), capability, skill, or effect that can be used by video game players or the video game to impact game play (e.g. bow, arrow, stealth attack, fire damage). Mechanics generally exclude items that do not impact game play (e.g. collectibles). The one or more fields and/or attributes in the content metadata for a mechanic can include a mechanic identifier and a name. The mechanic identifier is a unique identifier of the mechanic. The name can be a short localizable name of the mechanic. Other properties are possible including, for instance, an indication of whether the object should be treated as hidden for spoiler block uses cases (the default may be set to false), an image of the mechanic, and a short description of the mechanic. Multiple events about mechanics are possible.

An example of an event about a mechanic can indicate that the mechanics available to a video game player have changed. Availability of a mechanic represents that the mechanic is available in the game world for the video game player to use, but may necessitate the video game player to go through some steps to acquire it into inventory (e.g. download from a store, pick up from the world) before using it. This event can also be used to indicate lifting of spoiler block on the mechanic object, and to filter help tips to avoid suggesting use of a mechanic that is unavailable. The video game should replace the list of mechanics upon loading save data. A property of this event includes a list (e.g., array) of mechanics which are currently available.

Another example of an event about a mechanic can indicate that a video game player's inventory has changed. Inventory refers to mechanics that are immediately usable to the video game player without having to take additional steps in the video game before using it. Inventory information can be used to estimate a player's readiness for an activity. The video game should replace the list of inventories upon loading save data. A property of this event includes a list (e.g., array) of mechanics which are currently in inventory.

Yet another example of an event about a mechanic can indicate that a video game player's load out has changed. Load out represents the mechanics that are most immediately accessible to the video player, and is the subset of inventory which is displayable to the video game player. The video game should replace the list of mechanics upon loading save data. A property of this event includes a list (e.g., array) of mechanics which are now part of the active load out.

A further example of an event about a mechanic can indicate that the mechanic has been used by or against a video game player. Properties of this event include a list (e.g., array) of mechanics which were used (e.g. fire arrow, fire damage) and whether the mechanics were used by or against the video game player. Other properties are possible, such as optionally an initiator actor identifier (e.g., an identifier of the actor that initiated the use of the mechanic), a zone identifier of the initiator actor, and a position of the initiator actor.

Another example of an event about a mechanic can indicate that the mechanic had an impact on game play (e.g. an arrow hit a target). Properties of this event include a list (e.g., array) of mechanics which were used (e.g. fire arrow, fire damage) and whether the mechanics were used by or against a video game player. Other properties are possible, such as optionally the initiator actor identifier, the zone identifier of the initiator actor, the position of the initiator actor, a target actor identifier (e.g., an identifier of the actor targeted by the mechanic), a zone identifier of the target, a position of the target actor, and an identifier of a mechanic that mitigates the initiator's mechanic(s).

The video game platform 170, the queryable platform 150, or a combination thereof can also collect data about game media in a video game. The game media may represent a piece of media (text, audio, video, image) related to the video game. Game media may be provided by the game developer as a pre-rendered piece of media and/or algorithmically generated, such as a piece of media rendered by an in-game engine. The game media may exist in-game (e.g. cut-scene, audio log, book) or may not (e.g. developer commentary). The one or more fields and/or attributes in the content metadata for a piece of game media may include a game media identifier, a name, a format, a category, an unlock rule, and a uniform resource locator (URL). The game media identifier is a unique identifier of the game media. The name can be a localizable name of the game media. The format can indicate the media format, such as whether the game media is an image, audio, video, text, etc. The category indicates a type of the game media, such as whether the game media is a cut-scene, audio-log, poster, developer commentary, etc. The unlock rule indicates whether the game media should be unlocked for all video game players or based on an activity or a specific game media event. The URL references a server-provisioned media file, where this server can be part of the video game platform 170. Other properties are possible including, for instance, an indication of whether the object should be treated as hidden for spoiler block uses cases (the default may be set to false), an entitlement (e.g., indicating that only video game players who own a particular video game entitlement can unlock the game media), and an activity identifier (e.g., to associate the game media with a particular activity). Multiple events about game media are possible.

An example of an event about game media can indicate that a particular piece of game media has been unlocked for a video game player. A property of this event includes the game media identifier.

Another example of an event about game media can indicate that a particular piece of game media has started in the video game. The game media object should be considered unlocked for the video game player at the corresponding time. A property of this event includes the game media identifier.

Yet another example of an event about game media can indicate that a particular piece of game media has ended in the video game. A property of this event includes the game media identifier.

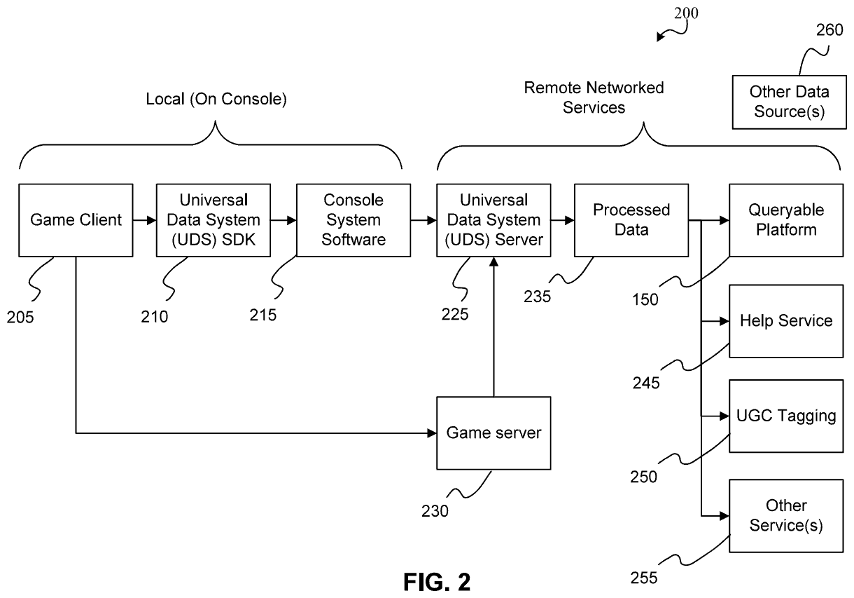

FIG. 2 illustrates an example of a system architecture 200 for providing contextual information related to a video game, according to embodiments of the present disclosure. In some embodiments, the exemplary system architecture 200 includes a game client 205, a universal data system (UDS) software development kit (SDK) 210, console system software 215, a local rule engine 220, a UDS server 225, a game server 230, processed data 235, the queryable platform 150, and one or more other remote networked services, including a help service 245, user generated content (UGC) tagging 250, and other service(s) 255. The help service 245 may also receive information from other data source(s) 260. Some of the components of the system architecture 200 are examples of components of the video game platform 170 of FIG. 1. For instance, the UDS server 225 and the game server 230 may be components of the video game platform 170.

The game client 205 and game server 230 provide contextual information regarding at least one application to a universal data system (UDS) server 225 via a UDS data model describing the logical structure of UDS data used by the UDS SDK 210. The UDS data model enables the platform (e.g., the video game platform 170) to realize remote networked services, such as the help service 245, UGC tagging 250, and other service(s) 255 that require game data, without requiring a game to be patched separately to support a service. The UDS data model assigns contextual information to a portion of information in a unified way across games. The contextual information from the game client 205 and UDS SDK 210 is provided to the UDS server 225 via the console system software 215. It is to be understood that the game client 205, UDS SDK 210, console system software 215, and local rule engine 220 may run on a computer or other suitable hardware for executing at least one application.

The UDS server 225 receives and stores contextual information from the game client 205 and game server 230 from at least one application. To be sure, the UDS server 225 may receive contextual information from a plurality of game clients and game servers for multiple users. The information may be uniformly processed 235 and then received by the plurality of remote networked services 245, 250, and 255. The information may further be received by the queryable platform 150, as described in further detail below with respect to FIGS. 3-9.

FIG. 3 illustrates an example of a system 300 for generating metadata 322 describing video game content, according to embodiments of the present disclosure. The system 300 may be a distributed computing environment that includes device(s) 330 and the queryable platform 150. The device 330 and the queryable platform 150 may be communicatively coupled via a network (e.g., such as the Internet or other suitable wide area network). The device 330 may correspond to one or more of the video game player devices 130, to the video game console 110, or a combination thereof. Accordingly, examples of the device 330 include a video game console, a video game controller, a smart phone, a tablet, a microphone, a personal computer, a laptop, other suitable devices, or a combination thereof. The queryable platform 150 may be a server-based video game service that may, among performing other operations, receive queries from and provide query results to the device 330.

In one example, the queryable platform 150 may receive a video game signal 302 related to an event 332 that occurred during game play of a video game 320 by a user of the device 330. An event can occur during any segment of game play of a video game. The event 332 can involve any actor, mechanic, zone, or other characteristic of the video game 320 with which the user comes into contact during game play of the video game 320. Examples of events are described above with respect to FIG. 1. Additional examples of events may include a game play against a particular actor of the video game 320, a game play within a particular zone of the video game 320, a game play in which a particular mechanic of the video game 320 was used. The event 332 may span a length of time (e.g., equal to or less than 1 minute, 30 minutes, or 60 minutes).

A video game signal may include any signal generated by a device while the user is playing a video game. For example, the video game signal 302 may include controller input 304. The controller input 304 may be indicative of how various buttons, joysticks, analog sticks, directional pads, touch screens, or the like of a controller were used by the user during the game play of the video game 320. Thus, the controller input 304 can include data indicative of analog stick movement, push-button presses, trigger-button presses, direction pad use, or the like. In another example, the video game signal 302 may include an audio input 306. For example, the user may use a microphone associated with the device 330 (e.g., associated with the controller 134 or the video game console 110) to provide voice commands. Thus, the audio input 306 may include the voice commands provided by the user during the game play. Additionally, or alternatively, the audio input 306 may include audio from the video game 320 during the game play. Moreover, the video game signal 302 can include chat input 308. The chat input 308 can include any text input provided or received by the user during the game play (e.g., from a chat session that occurred during that game play between the user and another user or an actor associated with the video game 320).

The video game signal 302 may also include settings of the video game 320 during the game play, settings of the device 330 (e.g., a controller or another video game device) used by the user for the game play, or a combination thereof. The video game settings 310 may include any user-selected numerical or textual value for a feature of the video game 320. For example, the video game settings 310 may include a user-selected difficulty level of the video game 320 during the game play, a user-selected gameplay mode of the video game 320 during the game play, or a user-selected environment of the video game 320 during the game play. The video game settings 310 may further indicate values (e.g., a value between 1 and 100) that features of the game were set to during the game play. Similarly, the video game settings 310 may indicate whether features were enabled or disabled during the game play. Conversely, the controller settings 312 may include any user-selected setting of the device 330. In one example in which the device 330 includes a controller, the controller settings 312 may include a user-selected sensitivity of the controller during the game play or a mapping of the buttons of the controller to actions in the video game 320 during the game play.

The queryable platform 150 may further receive video game data 314 related to the event. The video game data 314 may include a video 316 of the event 332. The video game data 314 may also include contextual information regarding the video game (e.g., the contextual information provided by the UDS server 225 of FIG. 2). The video game data 314 may further include data about a zone in the video game 320, data about an actor in the video game 320, data about a mechanic in the video game 320, data about game media in the video game 320, or a combination thereof as described above with respect to FIG. 1.

Once, the queryable platform 150 receives the video game signal 302 and the video game data 314, the video 316 can be labeled. The label may define or otherwise indicate the event 332 show in the video 316. Metadata 322 may also be generated to describe the event 332 and to describe a relationship between the event 332 and inputs received in association with the event 332 (the controller input 204, the audio input 206, the chat input 208, or other video game signals).

For example, the metadata 322 may include a name of the event 332, a description of the event 332, a state of the event 332 (whether ongoing, completed unsuccessfully, or completed successfully), whether an activity (of which the event may be an instance) is required to complete an objective or campaign in the video game 320, an in-game location (e.g., a zone) for where the event 332 took place, etc. The metadata 322 may further include: a list of actions exercisable by a user in the activity associated with the event 332, effects of each action, telemetry indicative of when an action took place including corresponding timestamps and locations. Similarly, the metadata 322 can include data associating the controller input 304, audio input 306, chat input 308, or the like with the actions and time stamps. Moreover, the metadata 322 may include data indicative of a speed of the controller inputs 304, a total time of the game play associated with the event 332, the video game settings 310, the controller settings 312, a time of when the game play occurred, etc. The metadata 222 may further include the label. Additionally, the metadata 322 may associate the video 316 with a player ID, a group of players ID, a session ID, a game ID, etc.

The video 316 may be labeled and the metadata 322 may be generated by inputting the video game data 314 and the video game signal 202 into one or more AI-models (e.g., AI-model 318). The AI-models may be trained to identify an event and generate the corresponding metadata using video game data and video game signals. For example, the AI-model 318 may be trained using a dataset of annotated videos (e.g., videos of game play of the video game 320 labeled with event information, such as a name of the event, a type of the event, or the like). The dataset for training may also include video game signals associated with the videos. The AI-model 318 can learn to recognize patterns and features associated with different types of videos and events for the video game 320. For example, the AI-model 318 may be able to identify an event in a video by recognizing characters, speech patterns, background images, or the like in a video. In some examples, the AI-model 318 can further learn to recognized patterns and features associated with different videos and events for more than one video game (e.g., video games within a same or similar genre as the video game 320). Moreover, the AI-model 318 may be trained to understand context of the video game 320, thereby ensuring that events are properly identified, labeled, and described. This might involve training the AI-model 318 on videos labeled with events and contextual information for the events (e.g., when the event may occur in a storyline of the video game).

The one or more AI-models (e.g., AI-model 318) can also be continuously updated and refined by incorporating new data from additional events and game play for one or more video game, thereby improving the accuracy and adaptability of the AI-models over time. This allows the AI-models to stay current with evolving game development practices and new types of game content and events. The system 300 may further incorporate a feedback loop that retrains the AI-models based on the manual verifications and/or modifications. This can ensure that the generated metadata and label for the video 316 accurately reflects the intended game design and logic of the video game 320.

In an example, the queryable platform 150 includes the AI-model 318 trained to generate, for the video 316 of the event 332, the metadata 322 with an indication 324 of the event 332 (e.g., a label) and a description 226 of the video game signal 202. For example, the AI-model 318 may analyze the video game data 314 (e.g., the video 216) and the video game signal 202 to identify the event 332, the user's actions during the event 332 (e.g., the controller inputs, the audio inputs, etc.), or other suitable information. The AI-model 318 might look for specific patterns in the video that indicate the event 332. Examples of patterns recognized in the video 316 may include an interaction of the with a particular actor associated the video game 320, dialogue of the actor, an image of a mechanic, actor, zone, or the like in the video, etc.

Using the patterns and the identified event, the AI-model 318 can generate the metadata 322 to describe the event 332 and the relationship of the event with the video game signal 302. For instance, if the video 316 includes a particular boss, the AI-model 318 may identify the event 332 as a boss battle and may generate the metadata 322 describing the boss battle (e.g., a time the battle took, a winner of the battle, etc.) and the video game signal 302 obtained during the boss battle (e.g., video game settings, controller settings, controller inputs, etc.).

The AI-model 318 can represent the metadata 322 in its latent space in some examples. Alternatively, the metadata 322 can be stored separately as plain text. As shown in FIG. 3, the video 316 is stored with the metadata 322 in a data store 328. The data store 328 may store the video 316 as well as numerous other videos in a structured manner. For example, the video 316 may be grouped with other videos relevant to similar video games (e.g., video games of the same or similar genre as video game 320), to the video game 320, to the event 332, or the like. In some examples, only the metadata may be stored in the data store 328. In such examples, the metadata 322 may include a network address or other means for accessing the video 316.

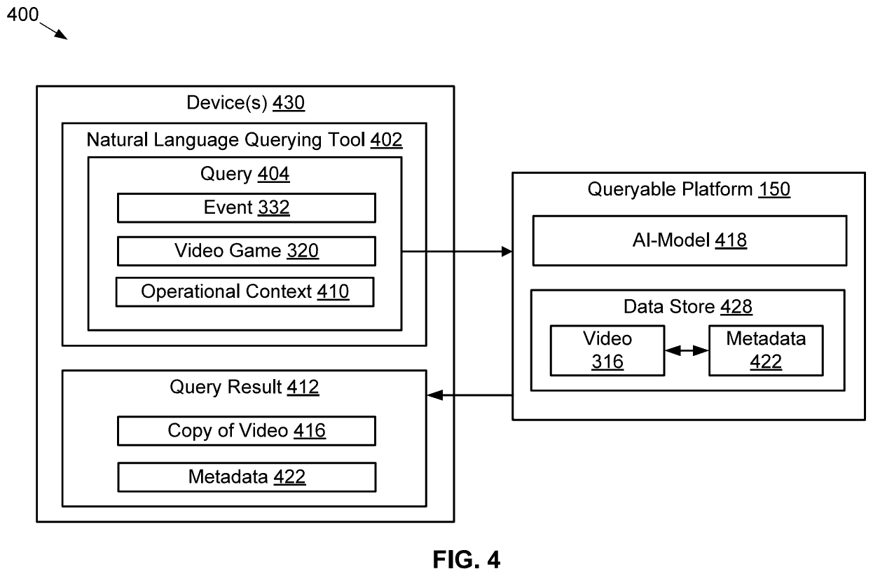

FIG. 4 illustrates an example of a system 400 for providing a query result 412 in response to a query 404 associated with the video game 320, according to embodiments of the present disclosure. The system 400 may be a distributed computing environment that includes device(s) 430 and the queryable platform 150. The device 430 and the queryable platform 150 may be communicatively coupled via a network (e.g., such as the Internet or other suitable wide area network). The device 430 may correspond to one or more video game player devices, a console, or a combination thereof. Accordingly, examples of the device 430 include a video game console, a video game controller, a smart phone, a tablet, a microphone, a personal computer, a laptop, other suitable devices, or a combination thereof. The device 330 of FIG. 3 may be a first device associated with a first user while the device 430 of FIG. 4 may be a second device associated with a second user.

In some examples, the queryable platform 150 may receive, from the device 430, a query 404 for one or more videos associated with the video game 320. The query 404 may correspond to a natural language input of the second user via the device 430. The second user may input the natural language input via a natural language querying tool 402 executing on the device 430. In one example, the query 404 is an audio input (e.g., speech) received by a microphone of the device 430. In another example, the query 404 may be a textual input that is input by the user via the natural language querying tool 402 on the device 430.

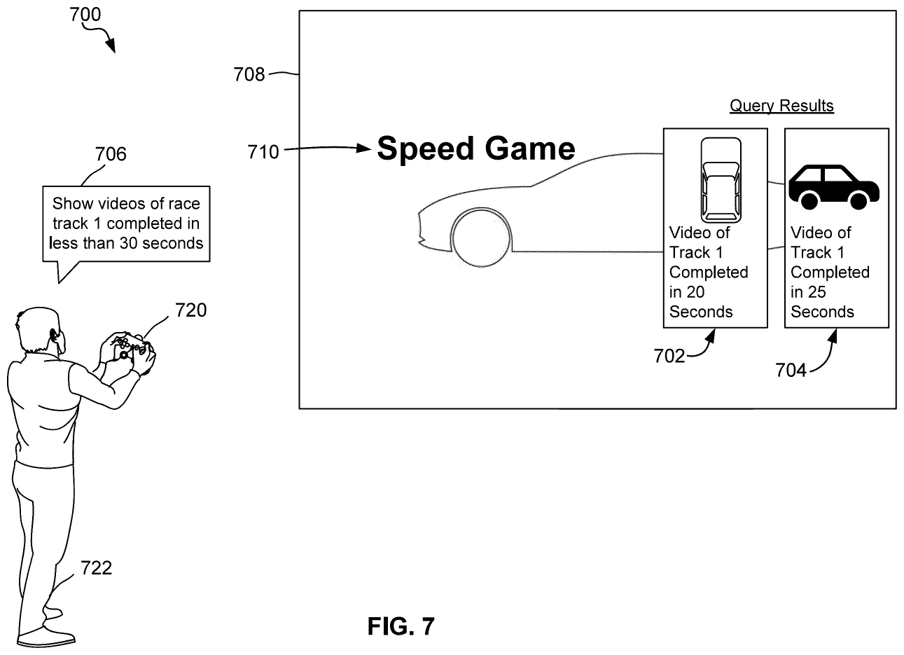

The query 404 may indicate an operational context 410 for an event 332 in the video game 320. The operational context 410 can be an aspect of the event 432 that is of interest to the second user. The operational context 410 can include any aspect of the event for which metadata may have been generated by the AI-model 318. For example, the operational context 410 be an in-game location (e.g., a zone) of the video game 320 for where the event took place. Additionally or alternatively, the operational context 410 may indicate controller inputs, a speed of the controller inputs, a timeframe for the event, video game settings, controller settings, or the like that is of interest to the second user. Moreover, the operational context 410 may be a player, a group of players, a session of the video game, or the like. An example of a query indicating an operational context is shown and described in further detail below with respect to FIG. 7.

In response to receiving the query 404 from the device 430, the queryable platform 150 may identify the video 316 of the event 332. To do so, the queryable platform 150 may determine that the metadata 322 associated with the video 316 indicates that the video 316 shows the event 332. Moreover, the queryable platform 150 may determine that the operational context 410 indicated in the query 404 matches the metadata 322 associated with the video 316. For example, the query 404 may have been a request for a video of a user completing the boss battle and defeating the boss using an actor with a particular set of skills. The metadata 322 may indicate that the video 316 is of the boss battle. The metadata 322 may further indicate that the first user was playing as the actor in the boss battle. Thus, the queryable platform 150 can determine that there is a match between the metadata 322 and the operational context 410.

Additionally, to determine the match between the operational context 410 and the metadata 322, the queryable platform 150 may analyze the query 404 to understand the operational context 410. To do so, the queryable platform 150 can use natural language processing and semantic analysis techniques to identify key words based on the query 404. Identifying key words may include identifying the key words from the natural language input that included the query 404. Identifying the key words may further include generating synonyms of the key words in the query 404. The queryable platform 150 may then parse videos with metadata (e.g., those stored in the data store 328) to identify relevant videos based on metadata for those videos including the key words. The queryable platform 150 may further rank the relevant videos based on how well the metadata associated with the video matches the query 404 (e.g., how many of the key words are found in the metadata), how new the video is (with newer videos being ranked higher), based on previous interactions of other users with the videos (e.g., based on how many or how long previous users have interacted with the videos), etc. The queryable platform 150 may further customize the query result 412 based on previous queries or other information related to the second user. For example, if the second user has previously accessed videos from game play of the first user, the video 316 related to the game play by the second user can be ranked higher.

After identifying and ranking the relevant videos, the queryable platform 150 may transmit a query result 412 indicative of one or more of the relevant videos to the device 430. For example, the queryable platform 150 may transmit a copy of the top ranked video (e.g., copy of the video 416) to the device 430 or a transmit a network address of a storage location of the video 316 to the device 430. Moreover, in some examples, the query result 412 may include metadata indicating an operational context of the event 332 in the video 316 to the device 430. As such, the device 330 may present the video 316 (or the copy of the video 416) with at least a portion of the operational context as part of presenting the query result 412. For example, the device 330 may display the video 316 with an indication that the video 316 includes the boss battle with the boss and the actor.

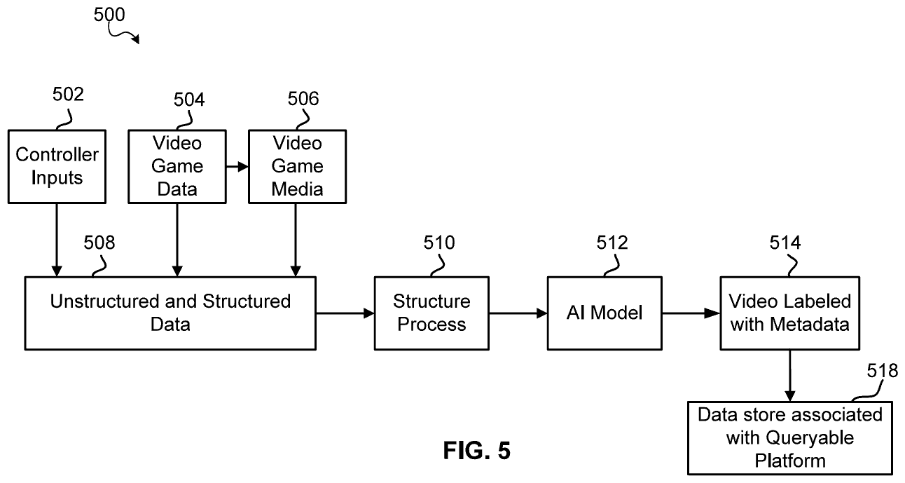

FIG. 5 illustrates an example of a system architecture 500 for generating metadata describing video game content, according to embodiments of the present disclosure. The exemplary system architecture 500 includes controller inputs 502, video game data 504, and video game media 506. The controller inputs 502, video game data 504, and video game media 506 can be received and combined as structured and unstructured data 508. For example, the controller inputs 502 can include structured data indicative of which buttons or other control systems (e.g., joysticks) of a video game controller were used during a game play of a video game. The controller inputs 502 may further be associated with time stamps or organized by an order in which they were detected. Conversely, the video game data 504 may be unstructured data that includes images, videos, audio, or the like from game play of the video game. Additional data may be obtained from the video game media 506, such as data associated with devices (e.g., controller settings), data associated with the video game (e.g., video game settings), or the like.

Once collected, the structured and unstructured data 508 may go through a structure process 510. In the structure process 510, the structured and unstructured data 508 may be organized into one or more structured formats (e.g., relational tables) to enable the data to be analyzed and for meaningful insights to be extracted from the data. The organized and structured data may then be input into an AI-model 512 trained to determine the event shown in the video game data 504 (e.g., in a video) and metadata for the event. The AI-model 512 can then output a video labeled with metadata 514. The metadata can indicate the event in the video game data and describe the controller inputs 502, the video game media 506, or other aspects of the structured data.

The video labeled with metadata 514 can be stored in a data store 518, which is associated with the queryable platform 150. The above can be performed repeatedly for various instances of gameplay of various video games. As a result, the data store 518 can include numerous videos of game play of video games labeled with metadata. The queryable platform 150 may use the videos labeled with metadata to provide query results in response to queries received from user devices, as described above with respect to FIG. 4.

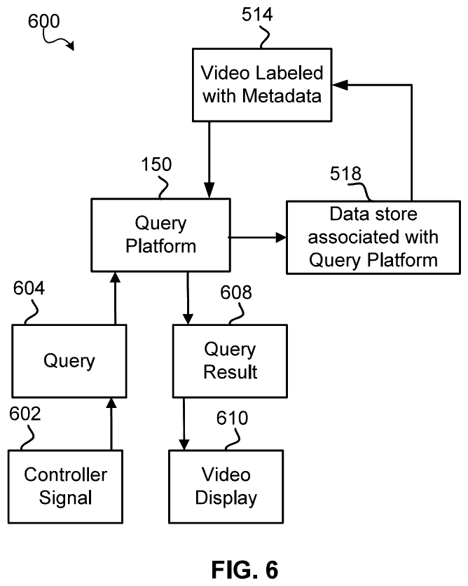

FIG. 6 illustrates an example of a system architecture 600 for providing a query result 608 in response to a query 604 associated with a video game, according to embodiments of the present disclosure. As shown in the system architecture 600, a controller signal 602 can be used to transmit a query to the queryable platform 150. The controller signal 602 may be transmitted via a controller or other suitable device. The controller signal 602 may include an audio or textual input that comprises the query 604. The query may indicate an operational context of an event of a video game.

The queryable platform 150 may then access the data store 518 and identify a video labeled with metadata 514. The video labeled with metadata 514 may be a video of the event and may correspond to a game play of the video game by a second user. The metadata may be generated by an AI-model (e.g., AI-model 512). The metadata associated with the video may indicate the event and a second operational context for the game play of the video game by the second user. Accordingly, the video may be identified by the queryable platform 150 determining, based on the indication of the event in the metadata, that the video shows the event. Additionally, the queryable platform 150 can determine that the second operational context matches the operational context for the event indicated in the query 604.

Subsequent to accessing the video labeled with metadata 514, the queryable platform 150 may transmit the query result 608 indicative of the video to the device. The query result may include a copy of the video or a network address of a storage location of the video. The video can then be displayed on video display 610 to the user.

FIG. 7 is a schematic example of a computing environment 700 for providing a query result in response to a query associated with a video game, according to embodiments of the present disclosure. In FIG. 7, a user 722 provides an audio input 706 with a query via a controller 720. In the example of FIG. 7, the query is a request for a video of an event of a video game (e.g., a race of a speed video game). The query of FIG. 7 further indicates an operational context for the event (e.g., that the race is at track 1 and is completed in less than 30 seconds).

The controller 720 can then transmit the audio input 706 comprising the query to the queryable platform 150, which can return a query result for display at a display device. FIG. 7 shows an example user interface 708 of the display device. The user interface 708 shows video game content 710 for the speed video game. The user interface 708 further shows query results 702, 704 overlaid on the video game content 710. The query results 702, 704 include a first video 702 and a second video 704. As described above, the query results 702, 704 may further include metadata indicating second operational context. As a result, the display device can present the videos and at least a portion of the second operational context as part of presenting the query results 702, 704. For example, as shown in FIG. 7, the first video 702 of the query results 702, 704 is shown with a description of the second operational context (e.g., that the video is of a race at track 1 completed in 20 seconds). Additionally, as shown in FIG. 7, the second video 704 of the query results 702, 704 is shown with a description of the second operational context (e.g., that the video is of a race at track 1 completed in 25 seconds).

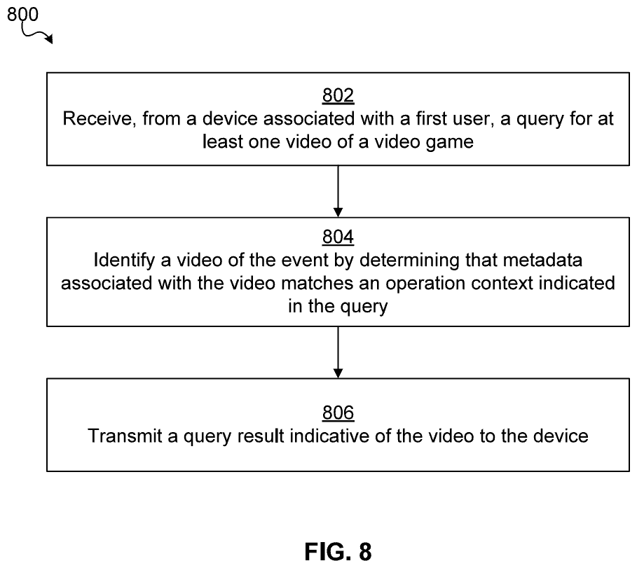

FIG. 8 is a flowchart of an example of a method 800 for providing a query result in response to a query associated with a video game, according to embodiments of the present disclosure. The steps of the method 800 can be implemented as hardware circuitry and/or stored as computer-readable instructions on a non-transitory computer-readable medium of a computer system, such as a video game console and/or a video game platform. As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is required and that certain operations can be omitted. The steps of FIG. 8 are described below with reference to components discussed above with respect to FIGS. 1-7 and 9.

At block 802, the method 800 involves receiving, from a device associated with a first user, a query for at least one video associated with a video game, the query indicating a first operational context for an event in the video game. The query may correspond to a natural language input of the first user via the device. For example, the natural language input may be text input by the user using the first device (e.g., a video game controller). In another example, the natural language input may be speech. FIG. 7 shows an example in which a user speaks into a microphone of a controller to provide the query as a natural language input.

At block 804, the method 800 involves identifying a video of the event by determining that metadata associated with the video matches the operational context indicated in the query. The video of the event may correspond to a game play of the video game by a second user.

The metadata may be generated by an AI-model (e.g., AI-model 318) trained to identify an event of a video game and generate metadata based on the event, video game data, and video game signals. The AI-model may receive video game data (e.g., videos) and video game signals (e.g., controller inputs and audio inputs) for various instances of game play of one or more video games from various user devices. When video game data (e.g., a video) and a video game signal from an instance of game play of a video game by a user is received from a device and input into the AI-model, the AI-model can generate metadata that indicates an event of the video game shown in the video and that describes operational context for the instance of game play. The operational context may denote characteristics of the video game (e.g., by denoting the genre of the video game), the event (e.g., by denoting a type of the event, a name of the event, an actor involved in the event, etc.), the user (e.g., by denoting a player ID of the user), the game play of the user (e.g., by denoting statistics associated with or characteristics of controller inputs, audio inputs, or chat inputs provided by the user during the instance of game play), video game settings (e.g., by denoting a game play mode of the video game during the instance of game play), controller settings (e.g., by denoting a sensitivity level of the controller used by the user during the instance of game play), or the like.

After the AI-model identifies the event and generates metadata, the metadata may be stored in a latent space of the AI-model, a data store, or the like. The processed video, which may be labeled with the event, may also be stored in the latent space, data store, or the like in association with the metadata. In some examples, the metadata may include a network address of a storage location of the video. Thus, using the AI-model, a digital repository of labeled videos and corresponding metadata can be created. This digital repository can then be used to identify relevant videos for queries.

Thus, prior to receiving the query, a video game signal and video game data related to the game play of the video game by the second user may have been received and input into the AI-model to generate the metadata. The video game signal may have included a controller input, an audio input, a chat input, settings of the video game, settings of a controller or a video game device used, or a combination thereof for the game play by the second user.

As mentioned above, the AI-model generates metadata that indicates an event shown in the video and that describes operational context for an instance of game play shown in a video. Therefore, the metadata associated with the video may indicate the event and a second operational context for the game play of the video game by the second user. The metadata may further include an identifier of the second user, of a game session of the game play, or a time of when the game play occurred. The second operational context may include a controller input of the second user for the game play, an indication of speed for the controller input, an indication of completion time of the event shown in the video, settings of the video game, or settings of a controller or a video game device used by the second user for the game play.

Accordingly, the video may be identified in part by determining, based on an indication of the event from the metadata, that the video shows the event indicated in the query. Additionally, to determine that metadata associated with the video matches the operational context indicated in the query, it can be determined that the second operational context matches a description of a queried video game signal indicated by the first operational context. For example, the metadata may indicate that the event shown in the video was performed with a set of video game settings. The description of the queried video game signal indicated by the first operational context may indicate that the user is requesting a video of the event being performed with the set of video game settings. Thus, it can be determined that there is a match between the second operational context provided via the metadata and the first operational context provided via the query.

In some examples, the AI-model may generate a second embedding of the second operational context in a latent space of the AI-model. In such examples, the video may be identified by at least generating a first embedding of the first operational context and matching the first embedding with the second embedding.

At block 806, the method 800 involves transmitting a query result indicative of the video to the device. The query result may include a copy of the video or a network address of a storage location of the video. Moreover, the query result may include metadata indicating the second operational context to the device such that the device presents the video and at least a portion of the second operational context as part of presenting the query result. For example, the query result may include the set of video game settings used by the second user during the game play associated with the video.

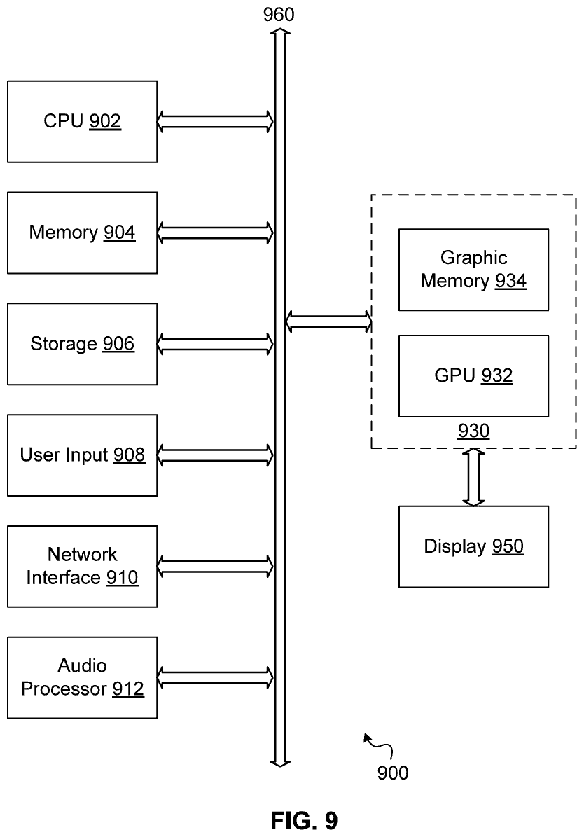

FIG. 9 illustrates an example of a hardware system suitable for implementing a computer system, according to embodiments of the present disclosure. The computer system 900 represents, for example, a video game console, a video game controller, a video game platform, a queryable platform, or other types of a computer system. The computer system 900 includes a central processing unit (CPU) 902 for running software applications and optionally an operating system. The CPU 902 may be made up of one or more homogeneous or heterogeneous processing cores. Memory 904 stores applications and data for use by the CPU 902. Storage 906 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 908 communicate user inputs from one or more users to the computer system 900, examples of which may include keyboards, mice, joysticks, touch pads, touch screens, game controllers, virtual reality controllers, still or video cameras, and/or microphones. Network interface 910 allows the computer system 900 to communicate with other computer systems via an electronic communications network, and may include wired or wireless communication over local area networks and wide area networks such as the Internet. An audio processor 912 is adapted to generate analog or digital audio output from instructions and/or data provided by the CPU 902, memory 904, and/or storage 906. The components of computer system 900, including the CPU 902, memory 904, data storage 906, user input devices 908, network interface 910, and audio processor 912 are connected via one or more data buses 960.

A graphics subsystem 930 is further connected with the data bus 1360 and the components of the computer system 900. The graphics subsystem 930 includes a graphics processing unit (GPU) 932 and graphics memory 1334. The graphics memory 934 includes a display memory (e.g., a frame buffer) used for storing pixel data for each pixel of an output image. The graphics memory 934 can be integrated in the same device as the GPU 932, connected as a separate device with the GPU 932, and/or implemented within the memory 904. Pixel data can be provided to the graphics memory 934 directly from the CPU 902. Alternatively, the CPU 902 provides the GPU 932 with data and/or instructions defining the desired output images, from which the GPU 932 generates the pixel data of one or more output images. The data and/or instructions defining the desired output images can be stored in the memory 904 and/or graphics memory 934. In embodiments, the GPU 932 includes 3D rendering capabilities for generating pixel data for output images from instructions and data defining the geometry, lighting, shading, texturing, motion, and/or camera parameters for a scene. The GPU 932 can further include one or more programmable execution units capable of executing shader programs.

The graphics subsystem 930 periodically outputs pixel data for an image from the graphics memory 934 to be displayed on the display device 950. The display device 950 can be any device capable of displaying visual information in response to a signal from the computer system 900, including CRT, LCD, plasma, and OLED displays. The computer system 900 can provide the display device 850 with an analog or digital signal.

In accordance with various embodiments, the CPU 902 is one or more general-purpose microprocessors having one or more processing cores. Further embodiments can be implemented using one or more CPUs 902 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 66%, 75%, 80%, 90%, 95%, 99%, 99.9% or, depending on the context within which the term substantially appears, value otherwise as known in the art.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A computer-implemented method comprising:
receiving, from a device associated with a first user, a query for at least one video associated with a video game, the query indicating a first operational context for an event in the video game;
in response to receiving the query:
identifying a video of the event by determining that metadata associated with the video matches the first operational context indicated in the query, the video of the event corresponding to a game play of the video game by a second user, and the metadata being generated by an AI-model and indicating a second operational context associated with the game play; and
transmitting a query result indicative of the video to the device.

2. The computer-implemented method of claim 1, wherein the query corresponds to a natural language input of the first user via the device.

3. The computer-implemented method of claim 1, further comprising, prior to receiving the query:
receiving a video game signal and video game data related to the game play of the video game by the second user, the video game data comprising the video of the event, the metadata generated by the AI-model based on the video game signal.

4. The computer-implemented method of claim 3, wherein the video game signal comprises one or more of: a controller input, an audio input, a chat input, settings of the video game, and settings of a controller or a video game device used by the second user for the game play.

5. The computer-implemented method of claim 3, wherein the metadata is generated by inputting the video game data and the video game signal to the AI-model, the metadata comprising an indication of the event being shown in the video and the second operational context, wherein the second operational context describes the video game signal.

6. The computer-implemented method of claim 5, wherein the second operational context comprises one or more of: a controller input of the second user for the game play, an indication of speed for the controller input, an indication of completion time of the event shown in the video, settings of the video game, and settings of a controller or a video game device used by the second user for the game play.

7. The computer-implemented method of claim 1, wherein identifying the video of the event comprises:
determining, based on an indication of the event from the metadata, that the video shows the event; and
determining, based on the second operation context related to the game play, that the second operational context matches a description of a queried video game signal indicated by the first operational context.

8. The computer-implemented method of claim 1, wherein transmitting the query result comprises transmitting a copy of the video to the device or a network address of a storage location of the video to the device.

9. The computer-implemented method of claim 1, wherein transmitting the query result comprises transmitting the metadata indicating the second operational context to the device such that the device presents the video and at least a portion of the second operational context as part of presenting the query result.

10. The computer-implemented method of claim 3, wherein the metadata is generated by inputting video game data and a video game signal corresponding to the game play to the AI-model, and wherein the AI-model is configured to generate a second embedding of the second operational context in a latent space of the AI-model, and wherein the video is identified by at least generating a first embedding of the first operational context and matching the first embedding with the second embedding.

11. The computer-implemented method of claim 1, wherein the metadata further comprises at least one of: an identifier of the second user, a game session of the game play, or a time of when the game play occurred.

12. A system comprising:
one or more processors; and
one or more memories storing instructions that, upon execution by the one or more processors, configure the system to perform operations comprising:
receiving, from a device associated with a first user, a query for at least one video associated with a video game, the query indicating a first operational context for an event in the video game;
in response to receiving the query:
identifying a video of the event by determining that metadata associated with the video matches the first operational context indicated in the query, the video of the event corresponding to a game play of the video game by a second user, and the metadata being generated by an AI-model and indicating a second operational context associated with the game play; and
transmitting a query result indicative of the video to the device.

13. The system of claim 12, wherein the query corresponds to a natural language input of the first user via the device.

14. The system of claim 12, wherein the operations further comprise, prior to receiving the query:
receiving a video game signal and video game data related to the game play of the video game by the second user, the video game data comprising the video of the event, the metadata generated by the AI-model based on the video game signal.

15. The system of claim 14, wherein the video game signal comprises one or more of: a controller input, an audio input, a chat input, settings of the video game, and settings of a controller or a video game device used by the second user for the game play.

16. The system of claim 14, wherein the metadata is generated, by inputting the video game data and the video game signal to the AI-model, the metadata comprising an indication of the event being shown in the video and the second operational, wherein the second operational context describes the video game signal.

17. The system of claim 16, wherein the second operational context comprises one or more of: a controller input of the second user for the game play, an indication of speed for the controller input, an indication of completion time of the event shown in the video, settings of the video game, and settings of a controller or a video game device used by the second user for the game play.

18. One or more computer-readable storage media storing instructions that, upon execution by one or more processors, cause operations comprising:
receiving, from a device associated with a first user, a query for at least one video associated with a video game, the query indicating a first operational context for an event in the video game;
in response to receiving the query:
identifying a video of the event by determining that metadata associated with the video matches the first operational context indicated in the query, the video of the event corresponding to a game play of the video game by a second user, and the metadata being generated by an AI-model and indicating a second operational context associated with the game play; and
transmitting a query result indicative of the video to the device.

19. The one or more computer-readable storage media of claim 17, wherein the query corresponds to a natural language input of the first user via the device.

20. The one or more computer-readable storage media of claim 17, wherein the operations further comprise, prior to receiving the query:
receiving a video game signal and video game data related to the game play of the video game by the second user, the video game data comprising the video of the event, the metadata generated by the AI-model based on the video game signal.
